(19) United States
(12) Patent Application Publication
(10) Pub. No.: US 2008/0102695 A1
(43) Pub. Date: May 1, 2008

(54) Engaging structure of card connector

(75) Inventors: Wang-Cheng Lin, Taipei City (TW); Hui-Chih Chen, Taipei City (TW)

Correspondence Address: ROSENBERG, KLEIN & LEE, 3458 ELLICOTT CENTER DRIVE-SUITE 101, ELLICOTT CITY, MD, 21043, US

(73) Assignee: Longwell Company, Taipei city (TW)

(21) Appl. No.: 11/647,342

(22) Filed: Dec. 29, 2006

(30) Foreign Application Priority Data
Oct. 27, 2006 (TW) 95218992

(51) Int. Cl. H01R 13/60

(52) U.S. Cl. 439/570

(57) ABSTRACT

An engaging structure for a card connector includes: an insulation housing having a base and plural apertures penetrating through the base, wherein plural conductive terminals are arranged within those apertures and partially extended to one side of the base, and plural positioning trenches are holed on this side of the base; a metal shell partially covering the insulation housing; and plural hooking holes formed by bending one side of the metal shell downwardly, wherein the hooking holes are set opposite to the positioning trenches, and plural resilient-sheets adaptable to engaging with the positioning trenches are extended from one side of every hooking hole. Accordingly, the hooking structure and the positioning trench structure can cooperate with each other, so that the insulation housing can engage with the metal shell tightly. Additionally, they can be easily disassembled when reworking.

### BACKGROUND OF THE INVENTION

1. Field of the Invention

The present invention relates to a connector, and more particularly, to a connector for a memory card.

2. Description of the Prior Art

Because the semiconductor technology progresses prosperously day by day during the recently, the storage density and the transmission speed of flash memory grow rapidly. Therefore, the flash memory has directly replaced the traditional storage media, such as the hard disc, in many application fields. The memory card, which is popularly welcomed by users, adopting the flash memory has been developed owing to the aforementioned advantages. Consequently, the demand of the card connector is simultaneously increasing. The major function of the card connector is to electrically connect the memory card and an electronic apparatus, and so as to make the electronic apparatus have the ability to access the internal data of the memory card and or store data into the memory card. Therefore, insertion trenches are commonly set for the memory card to insert. The memory card is positioned by the trenches, and the electrical connection is set up by assuring the contact of the electrical contacts of the memory card and the corresponding conductive terminals of the card connector.

Conventionally, the card connector is set on a Printed Circuit Board (PCB) to accommodate a memory card. Generally, the card connector includes an insulation housing, plural signal terminals and a metal shell. The signal terminals are configured in the insulation housing, and the metal shell covers the insulation housing to form an accommodating space for the memory card.

However, the conventional card connector usually adopts the bumps in cooperation with holes to complete the engagement action of the metal shell and the insulation housing. The disassembling is not easy if the card connector is malfunctioned or damaged. Furthermore, the hole area of the metal shell is easy to be deformed or broken by inadequate forcing of the user, which will increase a extra manufacture or repair cost.

### SUMMARY OF THE INVENTION

In order to solve the aforementioned problems, one object of the present invention is to provide an engaging structure of a card connector, which utilizes the hooking structure in cooperation with the positioning structure to more exactly complete the engagement action of the insulation housing and the metal shell.

One object of the present invention is to provide an engaging structure of a card connector, which the metal shell and the insulation housing are perpendicularly engaged. It is easy for both of the engagement and the disassembling because of the special engaging structure.

One object of the present invention is to provide an engaging structure of a card connector that is not only easily engaged but also easily dissembled, which the extra cost caused by the damage from the inadequate forcing of the user can be resolved through the improvement of the engaging structure.

To achieve the objects mentioned above, an engaging structure of a card connector of one embodiment of the present invention is provided, which includes: an insulation housing having a base and plural apertures penetrating through the base, wherein plural conductive terminals are arranged within those apertures and partially extended to one side of the base, and plural positioning trenches are holed on this side of the base; and plural hooking holes formed by bending one side of a metal shell downwardly, wherein the hooking holes are set opposite to the positioning trenches of the insulation housing, and plural resilient-sheets adaptable to engaging with the positioning trenches are extended from one side of every hooking hole.

To achieve the objects mentioned above, a card connector of another embodiment of the present invention is provided, which includes: an insulation housing having a base and plural apertures penetrating through the base, wherein plural conductive terminals are arranged within those apertures and partially extended to one side of the base, and plural positioning trenches are holed on this side of the base; a metal shell partially covering the insulation housing; and plural hooking holes formed by bending one side of the metal shell downwardly, wherein the hooking holes are set opposite to the positioning trenches of the insulation housing, and plural resilient-sheets adaptable to engaging with the positioning trenches are extended from one side of every hooking hole.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1A is a schematic decomposition diagram of a card connector according to one embodiment of the present invention;

FIG. 2A is the solid schematic diagram of a metal shell according to one embodiment of the present invention;

FIG. 2B is a partial amplified schematic diagram of a metal shell according to one embodiment of the present invention;

FIG. 2C is a partial amplified schematic diagram of a metal shell according to another embodiment of the present invention;

FIG. 3A is a front-view schematic diagram of an assembled card connector according to one embodiment of the present invention; and

FIG. 3B is a back-view schematic diagram of an assembled card connector according to one embodiment of the present invention.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

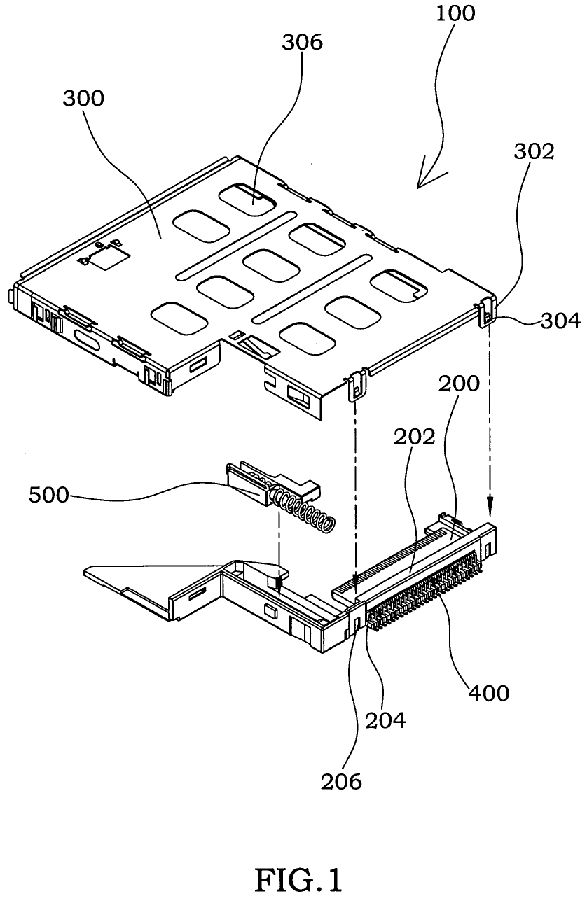

Firstly, please refer to FIG. 1, which is a schematic decomposition diagram of a card connector 100 according to one embodiment of the present invention. As shown in the figure, the card connector 100 includes: an insulation housing 200; a metal shell 300; and a plurality of hooking holes 302. Wherein the insulation housing 200 has a base 202 and a plurality of apertures 204 penetrating through the base 202; and a plurality of conductive terminals 400 are arranged within the apertures 204 and partially extended to one side of the base 202, which a plurality of positioning trenches 206 are holed on this side of the base 202. The metal shell 300 partially covers the insulation housing 200, and the hooking holes 302 are formed by bending one side of the metal shell 300 downwardly. The hooking holes 302 are set opposite to the positioning trenches 206 of the insulation housing 200, wherein a plurality of resilient-sheets 304 adaptable to engaging with the positioning trenches 206 of the insulation housing 200 are extended from one side of every hooking hole 302. In one embodiment, a receding element 500 is further included and set in the insulation housing 200 to facilitate a memory card to recede in the later application.

Continuing the above explanation, in one embodiment, the metal shell 300 is engaged with the insulation housing 200 along a perpendicular direction, such as the dash-lines shown in the figure. Utilizing the resilient-sheets 304 of the hooking holes 302 to match the positioning trenches 206 can stably engage the metal shell 300 with the insulation housing 200. If the disassembling and the reworking are required, it only needs to impose a horizontal force perpendicular to the engagement direction, which can easily disassemble the metal shell 300 to reduce the time consumed in the reworking. In another embodiment, a plurality of holes 306 may also be set in the metal shell 300 to increase the thermal dissipation ability of the card connector 100. Besides, the design of the holes 306 may reduce the total weight of the mechanical structure to match the trend of the lightness and thinness.

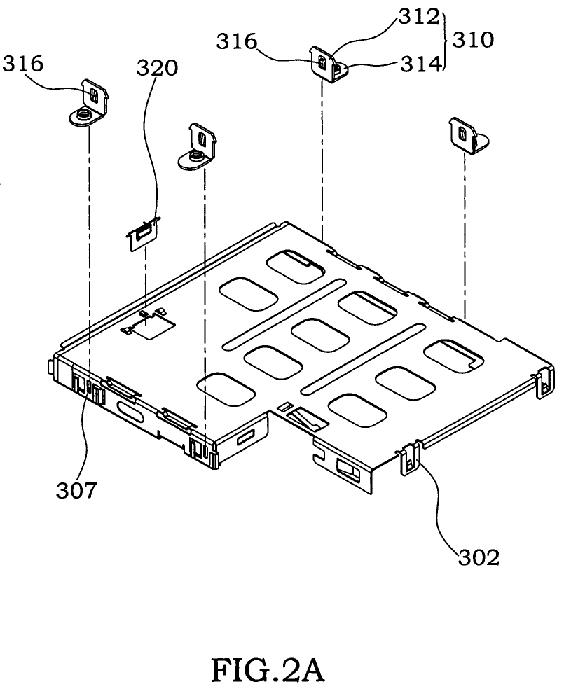

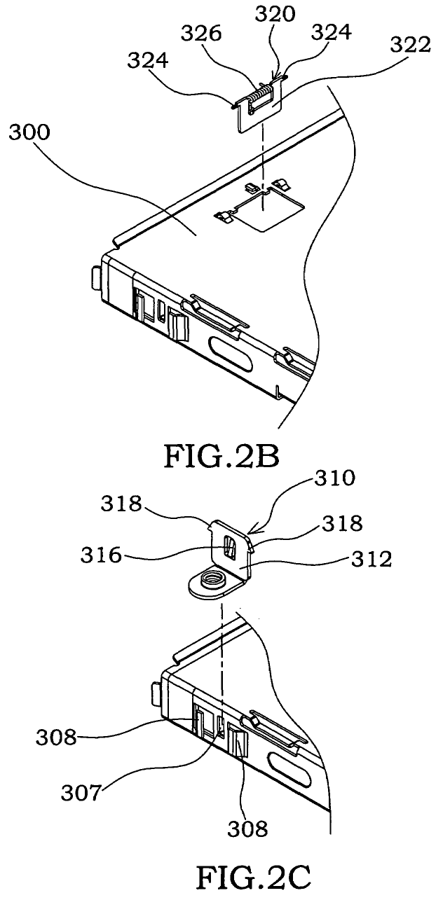

In one embodiment, please refer to FIG. 2A and FIG. 2B, which are the solid and partial amplified schematic diagrams of a metal shell according to one embodiment of the present invention. Wherein the card connector 100 further includes a guiding element 320 set in the metal shell 300, which may be set in one side away from the hooking holes 302 in one embodiment. As shown in the figure, the guiding element 320 includes a butting-plate 322 and a resilient element 326. Wherein one end of the butting-plate 322 outwardly extends a fixing protrusion-ear 324 to fix on the metal shell 300, and one end of the resilient element 326 is fixed in the butting-plate 322 and the other end can butt on the metal shell 300 later on. After the guiding element 320 is assembled in the metal shell 300, it may form a resilient-sheet structure that can be pushed and butted by a memory card.

In one another embodiment, please refer to FIG. 2A and FIG. 2C, FIG. 2C is a partial amplified schematic diagram of a metal shell according to another embodiment of the present invention. As shown in the figure, card connector 100 further includes a plurality of soldering-sheets 310 set in at least one side of the metal shell 300, and a plurality of clamping-portions 308 set in a side of the metal shell 300. Thus, the soldering-sheets 310 are fixed on the metal shell 300 by using these clamping-portions 308. In one embodiment, every soldering-sheet 310 has a positioning-portion 312 and a soldering-portion 314, and positioning-portion 312 has a positioning resilient-sheet 316 protruded by an angle. In another embodiment, a plurality of through holes 307 set in the metal shell 300 are provided for the positioning resilient-sheet 316 to go through and position. Besides, two shoulder-portions 318 can be defined by the positioning-portion 312.

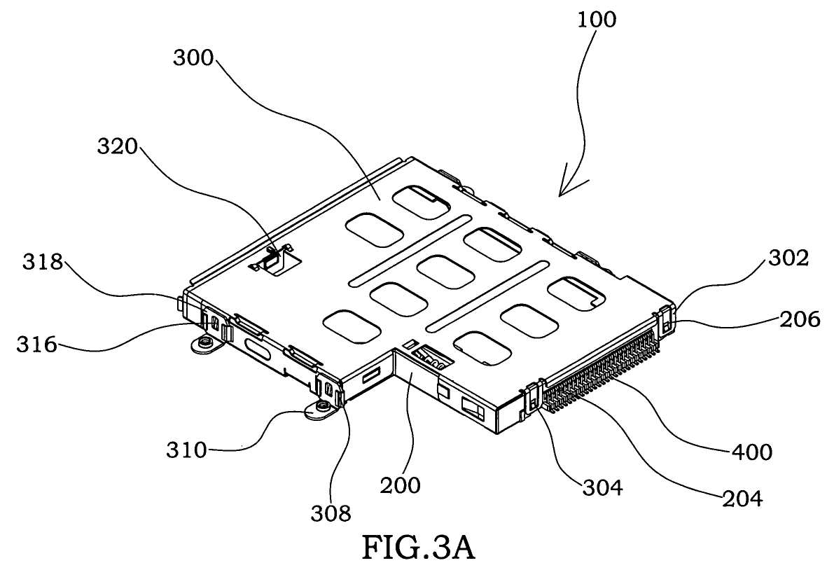

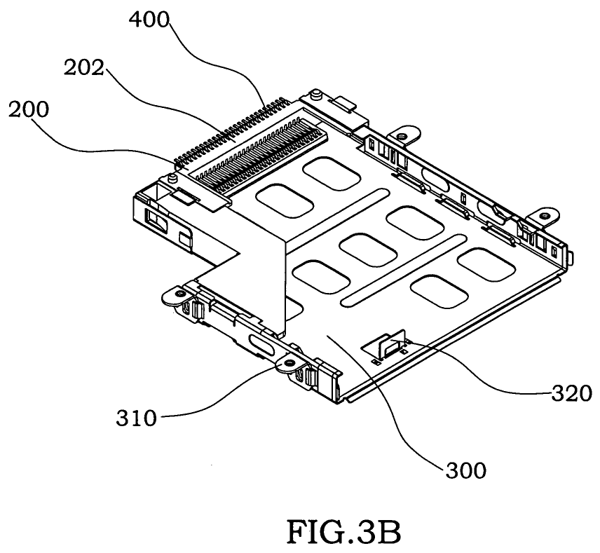

To continue the above description, FIG. 3A and FIG. 3B are the front-view and back-view schematic diagrams of the assembled card connector 100. In this embodiment, the engaging structure of the card connector 100 includes: an insulation housing 200 having a base 202 and plural apertures 204 penetrating through the base 202, wherein plural conductive terminals 400 are arranged within those apertures 204 and partially extended to one side of the base 202, and plural positioning trenches 206 are holed on this side of the base 202; and plural hooking holes 302 formed by bending one side of the metal shell 300 downwardly, wherein the hooking holes 302 are set opposite to the positioning trenches 206 of the insulation housing 200, and a plurality of resilient-sheets 304 adaptable to engaging with the positioning trenches 206 of the insulation housing 200 are extended from one side of every hooking hole 302. Utilizing the engaging structure constituted by the resilient-sheets 304 of the hooking holes 302 and the positioning trenches 206 can stably engage the metal shell 300 with the insulation housing 200. Further, if the disassembling and the reworking are required, it only needs to impose a horizontal force perpendicular to the engagement direction, which can easily disassemble the metal shell 300 to reduce the time consumed in the reworking.

Continuing the above explanation, in this embodiment, the conductive terminals 400 are extended from the insulation housing 200. Wherein one end of the exposed portion of the conductive terminals 400 may electrically connect to a corresponding connector, and the other end may contact with metal terminals of a inserted memory card. Therefore, the memory card can transfer data and communicate with an external apparatus through the conductive terminals 400.

Please refer to FIG. 3A, FIG. 3B and FIG. 2B, in one embodiment, the guiding element 320 after assembling forms a resilient-sheet structure that can be pushed and butted by a memory card. When the width of the memory card exceeds the preset location of the guiding element 320, the butting-plate 322 of the guiding element 320 will swing along with the pushing and butting of the memory card, which will not produce interference for the insertion action of the memory card. On the other hand, when the width of the memory card does not exceed the preset location of the guiding element 320, the butting-plate 322 of the guiding element 320 will form a structure to limit the memory card to be slanted because the main body of the memory card can not afford to push and butt the butting-plate 322. Wherein the shape and size of the butting-plate 322 may be designed depending on the personal favor of the user, which is not limited by that depicted in the figure.

To continue the above description, as shown in the figure, the positioning resilient-sheet 316 of the soldering-sheet 310 is protruded the plane defined by the positioning-portion 312, and the positioning resilient-sheet 316 is just exactly able to insert into the through holes 307 of the metal shell 300. Besides, the two shoulder-portions 318 of the positioning-portion 312 can lean against the clamping-portions 308 of the metal shell 300. Wherein the setting of the soldering-sheet 310 is to facilitate the metal shell 300 to solder to a printed circuit board.

According to the aforementioned description, one feature of the present invention is utilizing the special shape of the hooking hole to engage the metal shell with the insulation housing, it is convenient for both engagement and disassembling when reworking. And, other hooking holes or clasping hooks may be set on a side of the metal shell to reinforce the engaging structure of the metal shell and the insulation housing, and so as to avoid the deformation or detachment of the card connector induced by an external force. Besides, the guiding element of the metal shell has an advantage of changeability. It only needs to change the location or shape of the guiding element when the design of the insertion slot of the card connector changes, so the manufacturing process is very flexible. Furthermore, there are a plurality of holes set in the metal shell according to the present invention. They may not only to help good thermal dissipation, but also to reduce the mechanism weight.

To sum up, utilizing the hooking structure cooperated with the positioning trench structure can tightly engage the metal shell with the insulation housing. Furthermore, the metal shell is engaged with the insulation housing along a perpendicular direction and collocated with the special engaging structure, it may not only easily engage, but also be convenient to disassemble. In addition, the extra cost caused by the damage from the inadequate forcing of the user may also be resolved through the improvement of the engaging structure.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. A card connector, comprising:
an insulation housing having a base and a plurality of apertures penetrating through said base, wherein a plurality of conductive terminals are arranged within said apertures and partially extended to one side of said base, and a plurality of positioning trenches are holed on said side of said base;
a metal shell partially covering said insulation housing; and
a plurality of hooking holes formed by bending one side of said metal shell downwardly, wherein said hooking holes are set opposite to said positioning trenches of said insulation housing, and a plurality of resilient-sheets adaptable to engaging with said positioning trenches are extended from one side of every said hooking hole.

2. The card connector according to claim 1, wherein said metal shell is engaged with said insulation housing along a perpendicular direction.

3. The card connector according to claim 1, further comprising a guiding element set in said metal shell.

4. The card connector according to claim 3, wherein said guiding element is set in one side away from said hooking holes.

5. The card connector according to claim 3, wherein said guiding element comprises a butting-plate and a resilient element.

6. The card connector according to claim 5, wherein one end of said butting-plate outwardly extends a fixing protrusion-ear to fix on said metal shell.

7. The card connector according to claim 5, wherein one end of said resilient element is fixed in said butting-plate and the other end butts on said metal shell.

8. The card connector according to claim 1, further comprising a plurality of soldering-sheets set in at least one side of said metal shell and a plurality of clamping-portions set in said side, wherein said soldering-sheets are fixed on said metal shell by using said clamping-portions.

9. The card connector according to claim 8, wherein every soldering-sheet has a positioning-portion and a soldering-portion, wherein said positioning-portion has a positioning resilient-sheet protruded by an angle.

10. The card connector according to claim 9, wherein a plurality of through holes are set in said side of said metal shell for said positioning resilient-sheet to go through and position.

11. The card connector according to claim 9, wherein said positioning-portion has two shoulder-portions adaptable to leaning against said clamping-portions of said metal shell.

12. An engaging structure of a card connector, comprising:
an insulation housing having a base and a plurality of apertures penetrating through said base, wherein a plurality of conductive terminals are arranged within said apertures and partially extended to one side of said base, and a plurality of positioning trenches are holed on said side of said base; and
a plurality of hooking holes formed by bending one side of a metal shell downwardly, wherein said hooking holes are set opposite to said positioning trenches of said insulation housing, and a plurality of resilient-sheets adaptable to engaging with said positioning trenches are extended from one side of every said hooking hole.

13. The engaging structure of the card connector according to claim 12, wherein said metal shell is engaged with said insulation housing along a perpendicular direction.
